(19) United States
(12) Patent Application Publication
(10) Pub. No.: US 2005/0223385 A1
(43) Pub. Date: Oct. 6, 2005

(54) Method and structure for explicit software control of execution of a thread including a helper subthread

(76) Inventors: Christof Braun, Doonan (AU); Quinn A. Jacobson, Sunnyvale, CA (US); Shailender Chaudhry, San Francisco, CA (US); Marc Tremblay, Menlo Park, CA (US)

Correspondence Address: GUNNISON MCKAY & HODGSON, LLP, 1900 GARDEN ROAD, SUITE 220, MONTEREY, CA, 93940, US

(21) Appl. No.: 11/083,163

(22) Filed: Mar. 16, 2005

Related U.S. Application Data
(60) Provisional application No. 60/558,690, filed on Mar. 31, 2004.

(51) Int. Cl. G06F 15/76

(52) U.S. Cl. 718/108

(57) ABSTRACT

Software instructions in a single thread code sequence with a helper subthread are executed on a processor of a computer system. The execution causes the computer system, for example, to (i) determine whether information associated with a long latency instruction is available, and when the data is unavailable, to (ii) snapshot a state of the computer system and maintain a capability to roll back to that snapshot state, (iii) execute the helper instruction in the helper subthread, and (iv) roll back to the snapshot state upon completion of execution of the helper instructions in the helper subthread and continue execution. The helper subthread, for example prefetches data while waiting for the long latency instruction to complete.

### RELATED APPLICATIONS

This application claims the benefit of U.S. Provisional Application No. 60/558,690 filed Mar. 31, 2004 entitled “Method And Structure For Explicit Software Control Of Execution Of A Thread Including A Helper Subthread” and naming Christof Braun, Quinn A. Jacobson, Shailender Chaudhry, and Marc Tremblay as inventors, which is incorporated herein by reference in its entirety.

### BACKGROUND OF THE INVENTION

1. Field of the Invention

The present invention relates generally to enhancing performance of processors, and more particularly to methods for enhancing memory-level parallelism (MLP) to reduce the overall time the processor spends waiting for data to be loaded.

2. Description of Related Art

To enhance the performance of modern processors, various techniques are used to enhance the number of instructions executed in a given time period. One of these techniques is prefetching data that the processor needs in the future.

Prefetching data, in general, refers to mechanisms that predict data that will be needed in the near future and issuing transactions to bring that data as close to the processor as possible. Bringing data closer to the processor reduces the latency to access that data when, and if, the data is needed.

Many forms of data prefetching have been proposed to increase memory-level parallelism (MLP). One form of data prefetching uses hardware mechanisms that prefetch data based on various heuristics. Another form of data prefetching uses traditional software prefetches where directives are placed in the instruction stream to initiate the data prefetching.

Most instruction set architectures have a prefetch instruction that lets the software inform the hardware that the software is likely to need data at a given location, specified in the instruction, in the near future. Hardware then responds to these prefetch instructions by potentially moving data to close caches in the processor.

To use prefetch instructions, software must also include code sequences to compute addresses. These code sequences add an overhead to the overall execution of the program as well as requiring the allocation of some hardware resources, such as registers, to be dedicated to the prefetch work for periods of time. The potential benefit of data prefetching to reduce the time the processor spends waiting for data often more than compensates for the overhead of data prefetching, but not always. This is especially complicated because software has at best imperfect knowledge ahead of time of what data will already be close to the processor and what data needs to be prefetched.

### SUMMARY OF THE INVENTION

According to one embodiment of the present invention, explicit software control is used to perform helper operations while waiting for a long latency operation to complete. Herein, a long latency instruction is an instruction whose execution requires accessing information that is not available in a local cache or a use of a resource, which is unavailable when the instruction is ready to execute.

For example, while waiting for execution of a load instruction to complete, one or more prefetch instructions are executed along with additional computation needed to compute the addresses for the prefetch instructions. This is accomplished so that upon completion of the execution of the prefetch instruction, processing returns to the original code segment following the load instruction and execution continues normally.

Thus, periods of time that the processor is idle are recognized and only then are code sequences to prefetch data run. The code sequences for prefetching data are contained so that the code sequence do not effect the state or resource allocation of the main program.

In one embodiment, a computer-based method determines, under explicit software control, whether an item associated with a long latency instruction is available. A helper subthread is executed, under explicit software control, following the determining operation finding that the item associated with the long latency instruction is unavailable.

Execution of the helper subthread, under explicit software control results in checkpointing a state to obtain a snapshot state. In one example, the state is a processor state. Execution of the helper subthread, under explicit software control, also results in performing auxiliary operations by executing instructions in the helper subthread. Upon completion of the auxiliary operations, the state is rolled back to the snapshot state and an original code segment is executed using an actual value of the item.

Alternatively, the original code segment is executed using an actual value of the item following the determining finding the item associated with the long latency instruction is available. In this case, the helper subthread is not executed.

For this embodiment, a structure includes means for determining, under explicit software control, whether an item associated with a long latency instruction is available; and means for executing a helper subthread, under explicit software control, following the determining finding the item associated with the long latency instruction is unavailable.

The means for executing a helper subthread, under explicit software control includes means for checkpointing a state to obtain a snapshot state; means for performing auxiliary operations by executing instructions in the helper subthread; means for rolling the state back to the snapshot state. The structure also includes means for executing an original code segment using an actual value of the item.

These means can be implemented, for example, by using stored computer executable instructions and a processor in a computer system to execute these instructions. The computer system can be a workstation, a portable computer, a client-server system, or a combination of networked computers, storage media, etc.

For this embodiment, a computer system includes a processor and a memory coupled to the processor. The memory includes instructions stored therein instructions wherein upon execution of the instructions on the processor, a method comprises:
determining, under explicit software control, whether an item associated with a long latency instruction is available; and
executing a helper subthread, under explicit software control, following the determining finding the item associated with the long latency instruction is unavailable.

Also, for this embodiment, a computer-program product comprising a medium configured to store or transport computer readable code for the method described above and including:
determining, under explicit software control, whether an item associated with a long latency instruction is available; and
executing a helper subthread, under explicit software control, following the determining finding the item associated with the long latency instruction is unavailable.

In another embodiment, a computer-based method comprising:
determining, under explicit software control, whether an item associated with a long latency instruction is available; and
performing one of:
   (a) executing a helper subthread, under explicit software control, following the determining finding the item associated with the long latency instruction is unavailable; and
   executing an original code segment using an actual value of the item following completion of the executing the helper subthread; and
   (b) executing the original code segment using an actual value of the item following the determining finding the item associated with the long latency instruction is available.

For the another embodiment, a structure includes:
means for determining, under explicit software control, whether an item associated with a long latency instruction is available; and
means for performing one of:
   (a) executing a helper subthread, under explicit software control, following the determining finding the item associated with the long latency instruction is unavailable; and
   executing an original code segment using an actual value of the item following completion of the executing the helper subthread; and
   (b) executing the original code segment using an actual value of the item following the determining finding the item associated with the long latency instruction is available.

These means can be implemented, for example, by using stored computer executable instructions and a processor in a computer system to execute these instructions. The computer system can be a workstation, a portable computer, a client-server system, or a combination of networked computers, storage media, etc.

Similarly, a computer system includes a processor; and a memory coupled to the processor. The memory includes instructions stored therein instructions wherein upon execution of the instructions on the processor, a method comprises:
determining, under explicit software control, whether an item associated with a long latency instruction is available; and
performing one of:
   (a) executing a helper subthread, under explicit software control, following the determining finding the item associated with the long latency instruction is unavailable; and
   executing an original code segment using an actual value of the item following completion of the executing the helper subthread; and
   (b) executing the original code segment using an actual value of the item following the determining finding the item associated with the long latency instruction is available.

Also, a computer-program product comprising a medium configured to store or transport computer readable code for a method comprising:
determining, under explicit software control, whether an item associated with a long latency instruction is available; and
performing one of:
   (a) executing a helper subthread, under explicit software control, following the determining finding the item associated with the long latency instruction is unavailable; and
   executing an original code segment using an actual value of the item following completion of the executing the helper subthread; and
   (b) executing the original code segment using an actual value of the item following the determining finding the item associated with the long latency instruction is available.

### BRIEF DESCRIPTION OF THE DRAWINGS

FIG. 1 is a block diagram of a system that includes a source program including a single thread code sequence with a helper subthread that provides explicit software control of auxiliary operations according to a first embodiment of the present invention.

FIG. 2 is a process flow diagram for one embodiment of inserting a single thread with the helper subthread at appropriate points in a source computer program according to one embodiment the present invention.

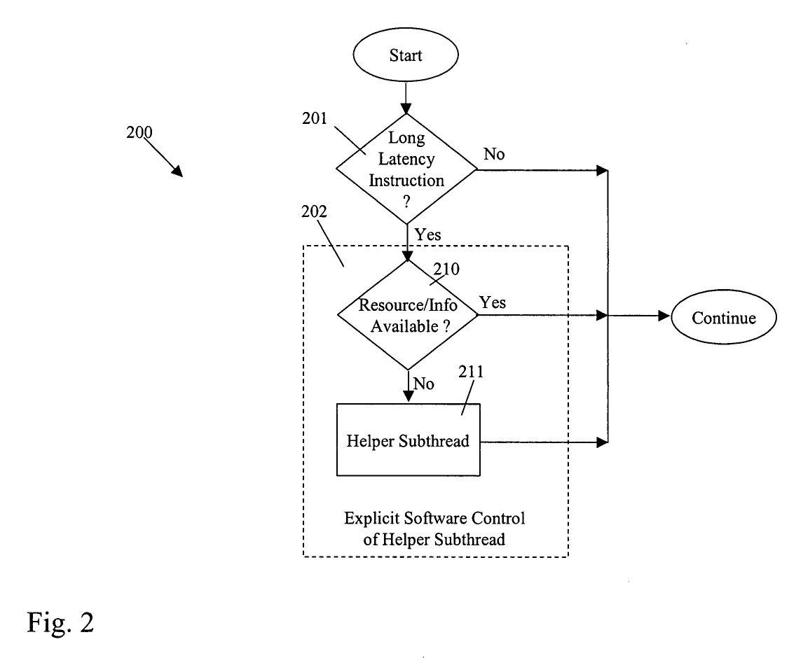

FIG. 3 is a process flow diagram for explicit software control of the helper subthread and of the auxiliary operations according to one embodiment of the present invention.

FIG. 4 is a high-level network system diagram that illustrates several alternative embodiments for using a source program including a single thread with a helper subthread.

In the drawings, elements with the same reference numeral are the same or similar elements. Also, the first digit of a reference numeral indicates the figure number in which the element associated with that reference numeral first appears.

### DETAILED DESCRIPTION

According to one embodiment of the present invention, a helper subthread is executed that performs useful work while a long latency instruction in a thread is waiting for data, for example. As explained more completely below, the execution of the helper subthread is performed under explicit software control.

A series of software instructions in a single thread code sequence with a helper subthread 140 is executed on a processor 170 of computer system 100. Execution of the series of software instructions in single thread code sequence 140 causes computer system 100, for example, to (i) determine whether data provided by a long latency instruction is available, and when the data is unavailable, (ii) snapshot a state of computer system 100 and maintain a capability to roll back to that snapshot state, (iii) execute the helper instruction in the helper subthread, and (iv) roll back to the snapshot state upon completion of execution of the helper instructions in the helper subthread and continue execution.

In one embodiment, the helper subthread prefetches data while waiting for the long latency instruction to complete. The data retrieved by execution of the helper subthread does not affect the snapshotted state of processor 170, for example. The data retrieved by the execution of the helper subthread can increase the instruction level parallelism when execution continues from the snapshot state.

A user can control the execution of the helper subthread using explicit software control in a source program 130. Alternatively, for example, a compiler or optimizing interpreter, in processing source program 130, can insert instructions that provide the explicit software control over the helper subthread at points where long latency instructions are anticipated.

Since the compiler or optimizing interpreter may not know conclusively whether a particular instruction will have a long latency on a given execution, the ability to check if the instruction will experience a long latency under software control assures that the helper subthread is executed only when a particular instruction encounters the long latency. Thus, as described more completely below, the helper subthread is inserted at points where long latency is expected, but if the data, functional unit, or other factor associated with the long latency is available, the code continues without execution of the helper subthread.

More specifically, in one embodiment, process 200 is used to modify program code to insert helper subthread at selected locations. In long latency instruction check operation 201, a determination is made whether execution of an instruction is expected to require a large number of processor cycles. If the instruction is not expected to require a large number of processor cycles, processing continues normally and the code is not modified to include a helper subthread at this point in the program code. Conversely, if the instruction is expected to require a large number of processor cycles, processing transfers to explicit software control of helper subthread operation 202 where instructions for explicit software control of execution of the helper subthread are included in source program 130.

In this embodiment, an instruction or instructions are added to source program 130 that upon execution perform resource/information available check operation 210. As explained more completely below, the execution of this instruction provides the program with explicit control over whether the helper subthread is executed. If the resource or information needed is available, processing continues normally. Conversely, if resource or information needed is unavailable, resource/information available check operation 210 transfers processing to helper subthread operation 211.

In helper subthread operation 211, in this embodiment, instructions are included so that operations (ii) to (iv) as described above are performed in response to execution of the helper subthread. Specifically, a software instruction directs processor 170 to take a snapshot of a state, and to manage all subsequent changes to that state so that if necessary, processor 170 can revert to the state at the time of the snapshot.

The snapshot taken depends on the state being captured. In one embodiment, the state is a system state. In another embodiment, the state is a machine state, and in yet another embodiment, the state is a processor state. In each instance, the subsequent operations are equivalent.

Following the snapshot, the helper code sequence is executed. Note that the helper code sequence does not require the result of the instruction that caused the long latency. When execution of the helper code sequence is completed, the state is rolled back to the snapshot state and execution continues.

For the explicit software control of the helper code sequence to be beneficial, the software application ideally has an operation for which the result is available after a long latency. The most common cause would be a long latency operation like a load that frequently misses the caches.

Other embodiments for determining where to insert the helper subthread in source program 130, e.g., insertion points, are disclosed in commonly assigned U.S. patent Ser. No. 10/349,425, entitled “METHOD AND STRUCTURE FOR CONVERTING DATA SPECULATION TO CONTROL SPECULATION” of Quinn A. Jacobson. The Summary of the Invention, Description of the Drawings, Detailed Description and the drawings cited therein, claims and Abstract of U.S. patent application Ser. No. 10/349,425 are incorporated herein by reference in their entireties.

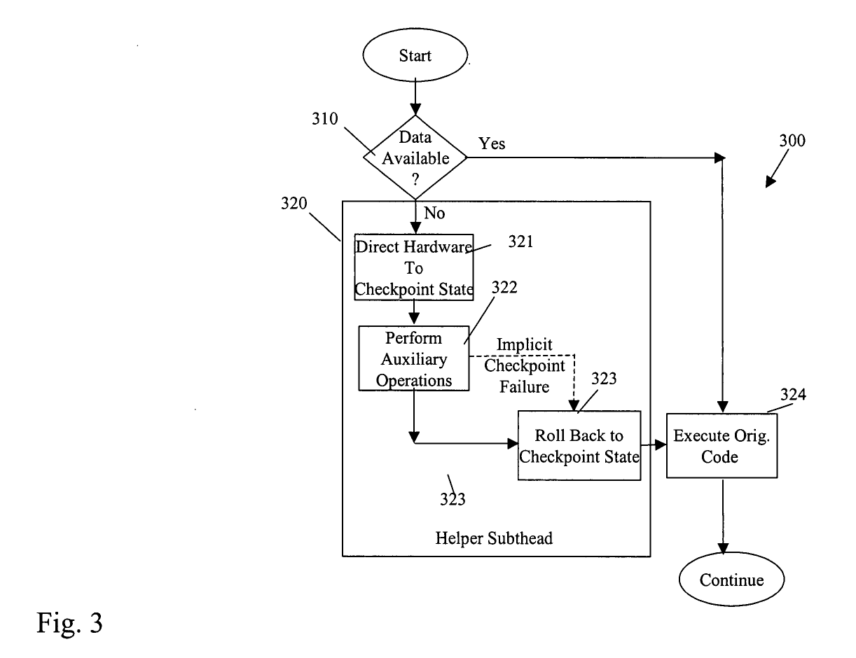

FIG. 3 is a more detailed process flow diagram for a method 300 for one embodiment of the instructions added, using method 200, to provide explicit software control of the execution of the helper subthread. To further illustrate method 300, pseudo code for various examples are presented below. An example pseudo code segment is presented in TABLE 1.

TABLE 1

1 Producer_OP A, B -> %rZ
. . .
2 Consumer_OP %rZ, C -> D
. . .

Line 1 (The line numbers are not part of the pseudo code and are used for reference only.) is an instruction, Producer_OP, which uses items A and B and places the result of the operation in register % rZ. The result of the execution of instruction Producer_OP may not be available until after a long latency.

Instruction Producer_OP can be any instruction supported in the instruction set. Items A and B are simply used as placeholders to indicate that this particular operation requires two inputs.

The various embodiments of this invention are also applicable to an operation that has a single input, or more than two inputs. Register % rZ can be any register. Also, herein, when it is stated that an instruction takes an action or uses information, those of skill in the art understand that such action or use is the result of execution of that instruction.

Line 2 is an instruction Consumer_OP. Instruction Consumer_OP uses the result of the execution of instruction Producer_OP that is stored in register % rZ. Items C and D are simply used as place holders to indicate that this particular operation requires two inputs % RZ and C and has an output D.

While in this embodiment instruction Consumer_OP is represented by a single line of pseudo-code, instruction Consumer_OP represents a code segment that uses the result of the execution of instruction Producer_OP. The code segment may include one of more lines of software code.

The pseudo code generated by using method 200 for the pseudo code in TABLE 1 is presented in lines Insert_{—}21 to Insert_{—}26 of TABLE 2.

TABLE 2

1 Producer_OP A, B -> %rZ
.
.
.
Insert_21 it %rZ unavailable, branch predict
. . .
Insert_22 original:
2 Consumer_OP %rZ, C -> D
.
.
.
Insert_23 predict;
Insert_24 checkpoint, original
Insert_25 <Helper Subthread Code >
Insert_26 Fail

Again, the line numbers are not part of the pseudo code and are used for reference only.

In this example, line 1 is identified as an insertion point and so a code segment, including lines Insert_{—}21, Insert_{—}22, Insert_{—}23, Insert_{—}24, Insert_{—}25, and Insert_{—}26 are inserted using method 200. The specific implementation of this sequence of instructions is dependent upon factors including some or all of (i) the computer programming language used in source program 130, (ii) the operating system used on computer system 100 and (iii) the instruction set for processor 170. In view of this disclosure, those of skill in the art can implement the conversion in any system of interest.

The inserted lines are first discussed and then method 300 is considered in more detail. Line Insert_{—}21 is a conditional flow control statement that upon execution determines whether the instruction has a long latency, e.g., is the actual result of the execution of instruction Producer_OP available.

If instruction Producer_OP has a long latency, e.g., the result of the execution of instruction Producer_OP is unavailable, processing branches to label predict, which is line Insert_{—}24. Otherwise, processing continues through label original, which is line Insert_{—}22, to line 2. Notice that the decision on whether the execution of instruction Producer_OP will have a long latency is made at run time and so is not dependent upon advance knowledge of the result of the execution of instruction Producer_OP.

Line Insert_{—}24 is an instruction that directs processor 170 to take the state snapshot and to maintain the capability to rollback the state to the snapshot state. In this example, a checkpoint instruction is used.

A more detailed description of methods and structures related to the checkpoint instruction are presented in commonly assigned U.S. patent application Ser. No. 10/764,412, entitled “Selectively Unmarking Load-Marked Cache Lines During Transactional Program Execution,” of Marc Tremblay, Quinn A. Jacobson, Shailender Chaudhry, Mark S. Moir, and Maurice P. Herlihy filed on Jan. 23, 2004. The Summary of the Invention, Description of the Drawings, Detailed Description and the drawings cited therein, claims and Abstract of U.S. patent application Ser. No. 10/764,412 are incorporated herein by reference in its entirety.

In this embodiment, the syntax of the checkpoint instruction is:
checkpoint, <label>
   where execution of instruction checkpoint causes the processor to take a snapshot of the state of this thread by the processor. Label <label> is a location that processing transfers to if the checkpointing fails, either implicitly or explicitly.

After a processor takes a snapshot of the state, the processor, for example, buffers new data for each location in the snapshot state. The processor also monitors whether another thread performs an operation that would prevent a rollback of the state, e.g., writes to a location in the checkpointed state, or stores a value in a location in the checkpointed state. If such an operation is detected, the speculative work is flushed, the snapshot state is restored, and processing branches to label <label>. This is an implicit failure of the checkpoint.

An explicit failure of the checkpointing is caused by execution of a statement Fail, which is the instruction in line Insert_{—}26. The execution of statement Fail causes the processor to restore the state to the snapshot state, and to branch to label <label>.

Line Insert_{—}25 is an instruction or code segment that makes up the helper instructions within the helper subthread. A new set of registers is made available for the subthread, and for example, the subthread prefetches data into the new set of registers. Upon completion of execution of line Insert_{—}25, the instruction Fail is executed which restores the checkpoint state and transfers processing to label original.

When the code segment in TABLE 2 is executed on processor 170, method 300 is performed. In data available check operation 310, a check is made to determine whether data needed or generated by the potentially long latency instruction is available. For example, if the result of this instruction was available, execution can continue normally without the delay that would be required to get the data. Thus, when the data is available, check operation 310 transfers processing to execute original code segment 324. Otherwise, when the result of the long latency instruction is unavailable, check operation 310 transfers processing to helper subthread 320.

In one embodiment of helper subthread 320, direct hardware to checkpoint state operation 321 causes a snapshot of the current state, the snapshot state, to be taken by processor 170. Upon completion of checkpoint state operation 321, processing transfers from operation 321 to perform auxiliary operations 322.

Perform auxiliary operations 322 executes the set of instructions that perform the helper operations, e.g., prefetch data. Upon completion, operation 322 transfers to roll back to checkpoint state operation 323.

In operation 323, an instruction that causes the checkpointing to fail is executed. As a result, the snapshot state is restored as the actual state and processing transfers to execute original code 324. Execute original code operation 324 executes the original code segment using the actual value from the long latency instruction.

In one embodiment, check operation 310 is implemented using an embodiment of a branch on status instruction, e.g., a branch on register not ready status instruction. Execution of the branch on register status instruction tests scoreboard 173 of processor 170 at the time the branch on register status instruction is dispatched. If the register status is ready, execution continues. If the register status is not ready, execution branches to a label specified in the branch on register status instruction. The format for one embodiment of the branch on register status instruction is:
Branch_if_not_ready % reg label
where
   % reg is a register in scoreboard 173, which in this embodiment is a hardware instruction scoreboard, and
   label is a label in the code segment.

With this instruction, the pseudo code of TABLE 2 becomes:

TABLE 3

1 Producer_OP A, B -> %rZ
. . .
Insert_31 Branch_if_not_ready %rZ predict
. . .
Insert_22 original:
2 Consumer_OP %rZ, C -> D
.
.
.
Insert_23 predict;
Insert_24 checkpoint, original
Insert_25 <Helper Subthread Code >
Insert_26 Fail

It is important that code making use of the branch on register status instruction understand the dispatch grouping rules and the expected latency of operations. If a branch on not ready instruction is issued immediately after a load instruction, the instruction typically would see the load as not ready because for example, the load has a three cycle minimum latency even for the case of a level-one data cache hit.

A more detailed description of the novel branch on status information instructions is presented in commonly filed, and commonly assigned U.S. patent application Ser. No. ______, entitled “METHOD AND STRUCTURE FOR EXPLICIT SOFTWARE CONTROL USING SCOREBOARD STATUS INFORMATION,” of Marc Tremblay, Shailender Chaudhry, and Quinn A. Jacobson (Attorney Docket No. SUN040062) of which the Summary of the Invention, Detailed Description, claims, Abstract and the drawings cited in these sections and the associated Brief Description of the Drawings are incorporated herein by reference in their entireties.

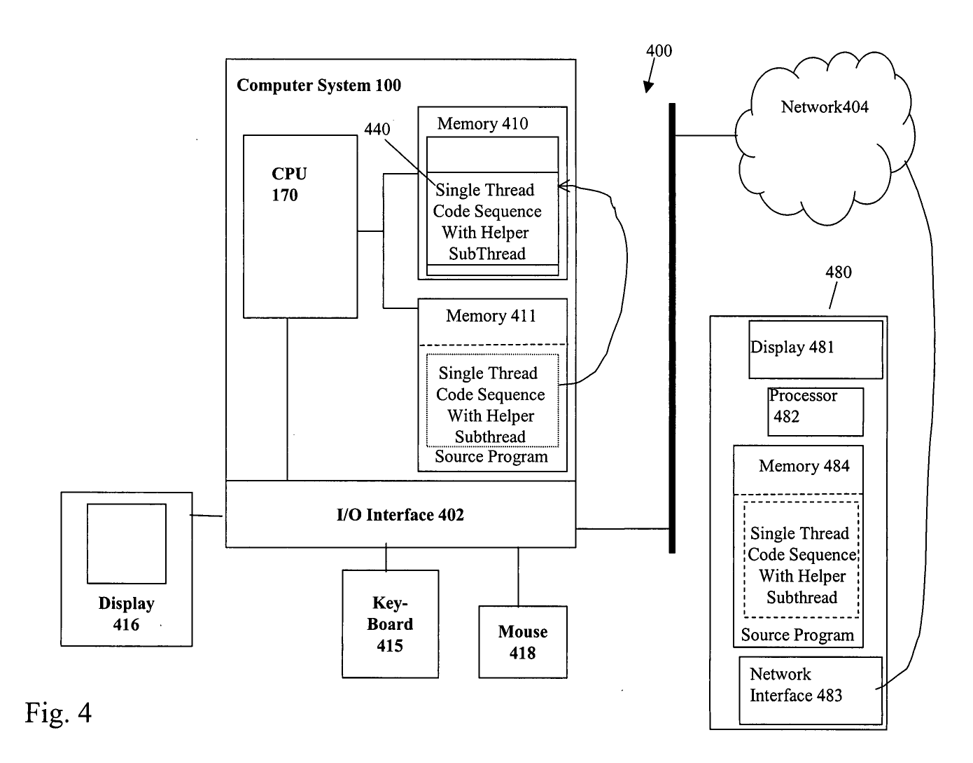

Those skilled in the art readily recognize that in this embodiment the individual operations mentioned before in connection with method 300 are performed by executing computer program instructions on processor 170 of computer system 100. In one embodiment, a storage medium has thereon installed computer-readable program code for method 440, (FIG. 4) where method 440 is method 300 in one example, and execution of the computer-readable program code causes processor 170 to perform the individual operations explained above.

In one embodiment, computer system 100 is a hardware configuration like a personal computer or workstation. However, in another embodiment, computer system 100 is part of a client-server computer system 400. For either a client-server computer system 400 or a stand-alone computer system 100, memory 120 typically includes both volatile memory, such as main memory 410, and non-volatile memory 411, such as hard disk drives.

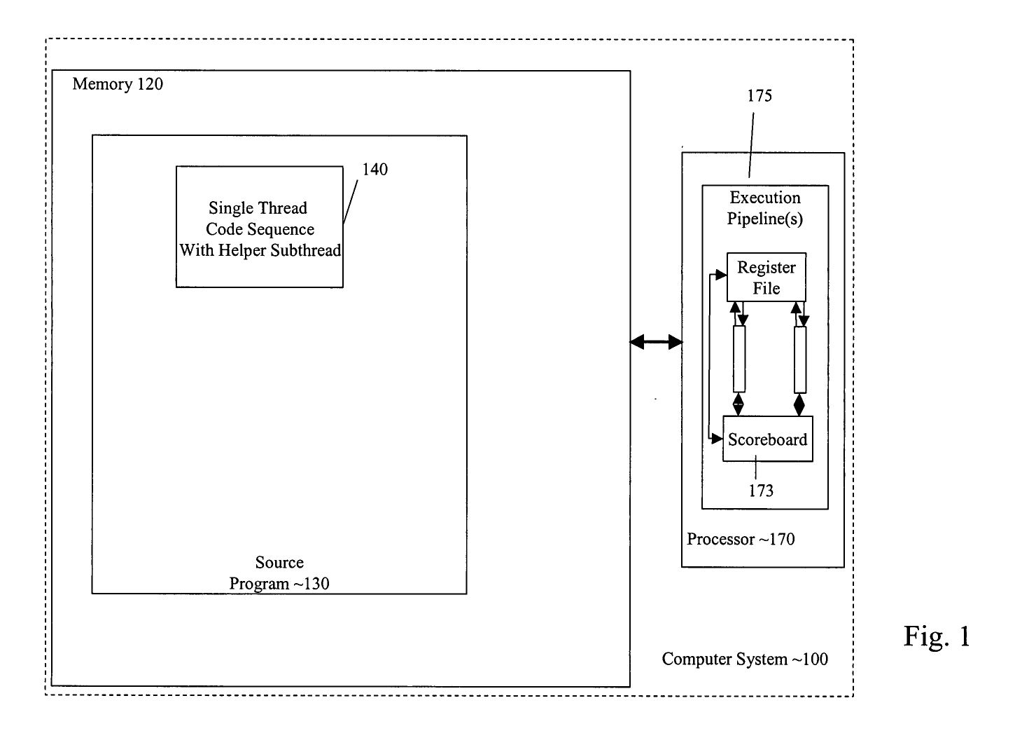

While memory 120 is illustrated as a unified structure in FIG. 1, this should not be interpreted as requiring that all memory in memory 120 is at the same physical location. All or part of memory 120 can be in a different physical location than processor 170. For example, method 440 may be stored in memory, e.g., memory 584, which is physically located in a location different from processor 170.

Processor 170 should be coupled to the memory containing method 440. This could be accomplished in a client-server system, or alternatively via a connection to another computer via modems and analog lines, or digital interfaces and a digital carrier line. For example, all of part of memory 120 could be in a World Wide Web portal, while processor 170 is in a personal computer, for example.

More specifically, computer system 100, in one embodiment, can be a portable computer, a workstation, a server computer, or any other device that can execute method 440. Similarly, in another embodiment, computer system 100 can be comprised of multiple different computers, wireless devices, server computers, or any desired combination of these devices that are interconnected to perform, method 440 as described herein.

Herein, a computer program product comprises a medium configured to store or transport computer readable code for method 440 or in which computer readable code for method 440 is stored. Some examples of computer program products are CD-ROM discs, ROM cards, floppy discs, magnetic tapes, computer hard drives, servers on a network and signals transmitted over a network representing computer readable program code.

Herein, a computer memory refers to a volatile memory, a non-volatile memory, or a combination of the two. Similarly, a computer input unit, e.g., keyboard 415 and mouse 418, and a display unit 416 refer to the features providing the required functionality to input the information described herein, and to display the information described herein, respectively, in any one of the aforementioned or equivalent devices.

In view of this disclosure, method 440 can be implemented in a wide variety of computer system configurations using an operating system and computer programming language of interest to the user. In addition, method 440 could be stored as different modules in memories of different devices. For example, method 440 could initially be stored in a server computer 480, and then as necessary, a module of method 440 could be transferred to a client device and executed on the client device. Consequently, part of method 440 would be executed on server processor 482, and another part of method 440 would be executed on the processor of the client device.

In yet another embodiment, method 440 is stored in a memory of another computer system. Stored method 440 is transferred over a network 404 to memory 120 in system 100.

Method 440 is implemented, in one embodiment, using a computer source program 130. The computer program may be stored on any common data carrier like, for example, a floppy disk or a compact disc (CD), as well as on any common computer system's storage facilities like hard disks. Therefore, one embodiment of the present invention also relates to a data carrier for storing a computer source program for carrying out the inventive method. Another embodiment of the present invention also relates to a method for using a computer system for carrying out method 440. Still another embodiment of the present invention relates to a computer system with a storage medium on which a computer program for carrying out method 440 is stored.

While method 440 hereinbefore has been explained in connection with one embodiment thereof, those skilled in the art will readily recognize that modifications can be made to this embodiment without departing from the spirit and scope of the present invention.

The functional units, register file 171, and scoreboard 173 are illustrative only and are not intended to limit the invention to the specific layout illustrated in FIG. 1. A processor 170 may include multiple processors on a single chip. Each of the multiple processors may have an independent register file and scoreboard or the register file and scoreboard may, in some manner, be shared or coupled. Similarly, register file 171 may be made of one or more register files. Also, the functionality of scoreboard 173 can be implemented in a wide variety of ways known to those of skill in the art, for example, hardware status bits could be sampled in place of the scoreboard. Therefore, use of a scoreboard to obtain status information is illustrative only and is not intended to limit the invention to use of only a scoreboard.

1. A computer-based method comprising:
determining, under explicit software control, whether an item associated with a long latency instruction is available; and
executing a helper subthread, under explicit software control, following the determining finding the item associated with the long latency instruction is unavailable.

2. The computer-based method of claim 1 wherein the executing a helper subthread, under explicit software control further comprises:
checkpointing a state to obtain a snapshot state.

3. The computer-based method of claim 2 wherein the state comprises a processor state.

4. The computer-based method of claim 2 wherein the executing a helper subthread, under explicit software control, further comprises:
performing auxiliary operations by executing instructions in said helper subthread.

5. The computer-based method of claim 4 wherein the executing a helper subthread, under explicit software, control further comprises:
rolling the state back to the snapshot state.

6. The computer-based method of claim 5 further comprising:
executing an original code segment using an actual value of said item.

7. The computer-based method of claim 1 further comprising:
executing an original code segment using an actual value of said item following the determining finding the item associated with the long latency instruction is available.

8. The computer-based method of claim 1 wherein the determining comprises:
executing a branch on register status instruction.

9. The computer-based method of claim 7 wherein said branch on register status instruction is a branch on ready instruction.

10. A structure comprising:
means for determining, under explicit software control, whether an item associated with a long latency instruction is available; and
means for executing a helper subthread, under explicit software control, following the determining finding the item associated with the long latency instruction is unavailable.

11. The structure of claim 10 wherein the means for executing a helper subthread, under explicit software control further comprises:
means for checkpointing a state to obtain a snapshot state.

12. The structure of claim 11 wherein the state comprises a processor state.

13. The structure of claim 11 wherein the means for executing a helper subthread, under explicit software control, further comprises:
means for performing auxiliary operations by executing instructions in said helper subthread.

14. The structure of claim 13 wherein the means for executing a helper subthread, under explicit software, control further comprises:
means for rolling the state back to the snapshot state.

15. The structure of claim 14 further comprising:
means for executing an original code segment using an actual value of said item.

16. The structure of claim 10 further comprising:
means for executing an original code segment using an actual value of said item following the determining finding the item associated with the long latency instruction is available.

17. The structure of claim 16 wherein the determining comprises:
means for executing a branch on register status instruction.

18. The structure of claim 16 wherein said branch on register status instruction is a branch on ready instruction.

19. A computer system comprising:
a processor; and
a memory coupled to the processor and having stored therein instructions wherein upon execution of the instructions on the processor, a method comprises:
determining, under explicit software control, whether an item associated with a long latency instruction is available; and
executing a helper subthread, under explicit software control, following the determining finding the item associated with the long latency instruction is unavailable.

20. A computer-program product comprising a medium configured to store or transport computer readable code for a method comprising:
determining, under explicit software control, whether an item associated with a long latency instruction is available; and
executing a helper subthread, under explicit software control, following the determining finding the item associated with the long latency instruction is unavailable.

21. The computer-program product of claim 20 wherein the method further comprises:
executing an original code segment using an actual value of said item following the determining finding the item associated with the long latency instruction is available.

22. A computer-based method comprising:
determining, under explicit software control, whether an item associated with a long latency instruction is available; and
performing one of:
(a) executing a helper subthread, under explicit software control, following the determining finding the item associated with the long latency instruction is unavailable; and
executing an original code segment using an actual value of said item following completion of the executing the helper subthread; and
(b) executing the original code segment using an actual value of said item following the determining finding the item associated with the long latency instruction is available.

23. A structure comprising:
means for determining, under explicit software control, whether an item associated with a long latency instruction is available; and
means for performing one of:
(a) executing a helper subthread, under explicit software control, following the determining finding the item associated with the long latency instruction is unavailable; and
executing an original code segment using an actual value of said item following completion of the executing the helper subthread; and
(b) executing the original code segment using an actual value of said item following the determining finding the item associated with the long latency instruction is available.

24. A computer system comprising:
a processor; and
a memory coupled to the processor and having stored therein instructions wherein upon execution of the instructions on the processor, a method comprises:
determining, under explicit software control, whether an item associated with a long latency instruction is available; and
performing one of:
(a) executing a helper subthread, under explicit software control, following the determining finding the item associated with the long latency instruction is unavailable; and
executing an original code segment using an actual value of said item following completion of the executing the helper subthread; and
(b) executing the original code segment using an actual value of said item following the determining finding the item associated with the long latency instruction is available.

25. A computer-program product comprising a medium configured to store or transport computer readable code for a method comprising:
determining, under explicit software control, whether an item associated with a long latency instruction is available; and
performing one of:
(a) executing a helper subthread, under explicit software control, following the determining finding the item associated with the long latency instruction is unavailable; and
executing an original code segment using an actual value of said item following completion of the executing the helper subthread; and
(b) executing the original code segment using an actual value of said item following the determining finding the item associated with the long latency instruction is available.
